(19) United States
(12) Patent Application Publication
(10) Pub. No.: US 2018/0325757 A1
(43) Pub. Date: Nov. 15, 2018

(54) Carry Pack

(71) Applicant: Irene SCHMID, Vancouver (CA)

(72) Inventor: Irene SCHMID, Vancouver (CA)

(21) Appl. No.: 15/976,235

(22) Filed: May 10, 2018

Related U.S. Application Data
(60) Provisional application No. 62/505,195, filed on May 12, 2017.

(51) Int. Cl. A61G 5/10

(52) U.S. Cl. CPC A61G 5/10

(57) ABSTRACT

The invention describes a carry pack. More specifically, the present invention relates to a carry pack configured for use with a wheelchair, such as a tilt-in-space wheelchair, by a plurality of primary attachment points capable of being attached to the back canes of the wheelchair.

### FIELD OF INVENTION

The present invention relates to a carry pack. More specifically, the present invention relates to a carry pack for use with a wheelchair.

### BACKGROUND OF THE INVENTION

Many persons with severe disabilities spend several hours a day in a wheelchair, both inside and outside their homes. Such persons often have special requirements such as medication, incontinence management, and/or gastric-tube feeding which require access to specific items such as documents, medication, specialty nutrition, diapers, wet wipes, bibs, and/or a change of clothing. Severely disabled persons are commonly assisted by a personal healthcare provider or caregiver, especially when traveling outside their home.

Wheelchairs are generally designed to be operated on an incline, up and down curbs, and over uneven surfaces. Many wheelchairs are therefore subject to a range of fore and aft tilting, or pitch, and sometimes also side to side tilting, or roll. One type of wheelchair commonly provided for persons with severe disabilities is called a tilt-in-space wheelchair. This style of wheelchair has the added feature of allowing the seat, back and foot-rest to tilt without changing the seat-to-back angle. Tilting can help with the management of reflux and relieve skin pressure points when the user is seated for prolonged periods,

Many wheelchair users and/or their caregivers attach some type of carrier to a wheelchair for the transportation and storage of personal effects, medically-necessary materials, and/or equipment. Often, a standard book-bag or knapsack is placed over the handles of the wheelchair to carry these items. Doing so can be unwieldy and sometimes unsafe as it may interfere with the break and tilt levers and cables and/or significantly impact the balance of the wheelchair, particularly a tilt-in-space wheelchair.

### SUMMARY OF THE INVENTION

The present invention relates to a Carry Pack.

In one aspect, the Carry Pack may include central compartment defined by two side panels, a front panel, a back panel, a base and a top, where the side panels include a plurality of primary attachment points attachable to the back canes of a wheelchair with a connector complementary to the primary attachment points.

In some embodiments, the connector may include a hook, a carabiner, a buckle, or a tie fastener.

In some embodiments, the primary attachment points may be positioned at the top half of the side panels.

In some embodiments, the primary attachment points may be positioned at various locations in the side panels.

In some embodiments, the primary attachment points may be positioned at a diagonal in the side panels.

In some embodiments, the primary attachment points may include loops, buckles, hooks, ties or elastics.

In some embodiments, the carry pack may include a plurality of secondary attachment points positioned at the bottom half of the side panels, where the secondary attachment points are attachable to the back canes of the wheelchair.

In some embodiments, the secondary attachment points may include loops, buckles, hooks, ties or elastics.

In some embodiments, the carry pack may further include a top-access compartment.

In some embodiments, the top-access compartment may include a beverage holder.

In some embodiments, the carry pack may further include a pouch attachable to the exterior of the carry pack.

In some embodiments, the pouch may be removable.

In some embodiments, the interior of the central compartment of the carry pack may include a plurality of interior trays.

In some embodiments, the interior trays may be removable.

In some embodiments, the interior trays may be repositionable.

In some embodiments, the base of the carry pack may be porous.

In some embodiments, the base of the carry pack may be removable.

In some embodiments, the carry pack may be made of a waterproof material.

In some embodiments, the carry pack may be made of a washable material.

In some embodiments, the wheelchair may be a tilt-in-space wheelchair.

This summary does not necessarily describe all possible features or functions of the invention.

### BRIEF DESCRIPTION OF THE DRAWINGS

These and other features of the invention will become more apparent from the following description in which reference is made to the appended drawings wherein:

FIG. 1. shows an isometric front view of an embodiment of the Carry Pack, closed;

FIG. 2. shows an isometric front view of an embodiment of the Carry Pack, open, without accessories;

FIG. 3. shows an isometric front view of an embodiment of the Carry Pack, open, with three trays;

FIG. 4. shows an isometric front view of an embodiment of the Carry Pack, with bottom net, configured to drain;

FIG. 5. shows an isometric back view of an embodiment of the Carry Pack;

FIG. 6. shows a top view of an embodiment of the Carry Pack with two top compartments open;

FIG. 7. shows an isometric view of an embodiment of an interior tray;

FIG. 8. shows an isometric view of an embodiment of a bottom net;

FIG. 9. shows an isometric view of one embodiment of a beverage holder;

FIG. 10. shows an isometric view of a second embodiment of a beverage holder; and

FIG. 11. shows an isometric view of a tilt-in space wheelchair, illustrating the mounting strategy of one embodiment of the Carry Pack.

### ANNOTATIONS TO THE DRAWINGS

Elements of one embodiment of a Carry Pack in accordance with the present disclosure, as depicted and identified by numbers within the Figures, are as follows:
1. Front flap;
2. Front flap pair fasteners;
3. Front flap bottom pair fasteners;
4. Top access compartments;
5. Opening in top-access compartment for beverage container;
6. Pair fastener closures for top-access compartments;
7. Side panels;
8. Primary Attachment Points, shown in the Figures as a webbing loop ladder anchored to a side panel, provide a range of attachment options;
9. Connectors, shown in Figures as an S-carabiner;
10. Secondary Attachment Points, shown in the Figures as a double Velcro™ webbing loop and ladder lock;
11. Pouch, shown in the Figures as detachable;
12. Pouch pair fasteners, shown in the Figures as three snap fits on top and one on the bottom of the pouch;
13. Interior trays, shown in the Figures as detachable;
14. Interior tray pair fasteners;
15. Bottom net, shown in Figures as detachable;
16. Bottom net pair fasteners;
17. Recess for headrest mount;
18. Rear attachment points for carry handle;
19. Top-access compartment hinges;
20. Beverage holder;
21. Flexible rim;
22. Inner ribs;
23. Outside lower rim;
24. Slip-over insulating foam cylinder;
25. Inner cylinder, shown in Figure as waterproof, wipe-able material;
26. Cylinder bottom, shown in Figure as made of waterproof, flexible, non-slip material;
27. Tilt-in-space wheelchair;
28. Wheelchair back canes;
29. Backrest mounting hardware on back canes, shown in Figure as one of numerous hardware configurations;
30. Headrest mount, shown in Figure as one of numerous mounting hardware options.

### DETAILED DESCRIPTION

The present disclosure describes, in part, a storage pack, referred to herein as a “Carry Pack.” In some embodiments, the Carry Pack may be used on a wheelchair. In some embodiments, the Carry Pack may be used on a tilt-in-space manual wheelchair. In alternative embodiments, the Carry Pack may be used on a powered wheelchair and/or on any manual wheelchair without a tilt-in-space function. It is to be understood however that the Carry Pack may be used on any suitable surface that is subject to rear or sideward tilting, where lateral access may be of benefit to the user(s).

In some embodiments, the design of the Carry Pack may be determined by frequency and urgency of use of the items required by disabled persons or “user” in tilt-in-space wheelchairs or their attendant caregivers. The user may, for example, have special requirements, including regular administration of medication, incontinence, g-tube feeding, and/or electronically enhanced communication. This requires carrying specific items such as prescription drugs, diapers, wet-wipes, specialty nutrition, bibs, and changes of clothing, such that they are at hand and quickly accessible as needs arise. In some embodiments, the caregiver may for example wish to carry keys, wallet, phone and a drink in the same Carry Pack. In some embodiments, the Carry Pack may accommodate the tilt of a wheelchair and/or be configured such that the contents stay secure and/or can be accessed in a variety of tilt positions.

In some embodiments, the Carry Pack may be accessible by the caregiver only and not by the user. This may be required for the safety of the user.

In some embodiments, the Carry Pack may be in the shape of a rectangular or trapezoidal prism. It is to be understood however that any shape that can be secured to the rear side of the backrest of a wheelchair and/or between the wheels is within the scope of the present disclosure.

In some embodiments, the Carry Pack may be affixed to the vertical back canes of a wheelchair, such as a manual tilt-in-space wheelchair, directly behind the backrest and headrest mount and between the wheels.

In some embodiments, the external dimensions of the Carry Pack may be configured to the width of the back canes and the back height of a wheelchair seating system. In some embodiments, the depth of the Carry Pack may be such that it does not interfere with the movement of the wheelchair, such as by a caregiver while pushing the wheelchair. In some embodiments, the Carry Pack may have a width of about 14″ to about 18″, a depth of about 7″ to about 10″, and a height of about 16″ to about 22″.

In some embodiments, the Carry Pack may include a central compartment defined by two side panels, a front panel, a back panel, a base and a top.

Each of the side panels may include a plurality of primary attachment points for attachment to a wheelchair. In some embodiments, the primary attachment points may be placed near the top or center of the side panels. In some embodiments, the primary attachment points may be placed near the center of mass of the Carry Pack. It is to be understood that the primary attachment points may be placed at any suitable location on the side panels to, for example, permit adjustment of the Carry Pack to enable a snug fit against the wheelchair back while remaining out of the way of wheelchair features such as hand brakes, foot-brake pedal, break cables, wheels and headrest. In some embodiments, the primary attachment points may be placed at a diagonal at an angle of about 15 degrees to about 25 degrees. In alternative embodiments, the primary attachment points may be placed in a matrix at various locations on the side panels. The primary attachment points may include any suitable attachment mechanism such as loops, buckles, hooks, ties or elastics. In some embodiments, the primary attachment points may include a plurality of loops. In some embodiments, the primary attachment points may be made from, for example, webbing. The webbing may be configured to form a plurality of loops.

The Carry Pack may be attached to a wheelchair backrest, or any other surface, by the primary attachment points using a connector. The connector can be repositioned on the primary attachment points to optimize the location of the Carry Pack on the wheelchair. This mounting approach can accommodate a range of back cane diameters and safety hardware configurations. For instance, some wheelchair hand brakes are mounted near the back cane curvature adjacent to the wheelchair handles. The Carry Pack is designed to be attached securely away from such important wheelchair hardware. In some embodiments, the connector may be without limitation a pair fastener such as an S-shaped hook, a carabiner, a lockable S-shaped dual carabiner, a buckle, any other hook or tie fastener that is complementary to the primary attachment point. In some embodiments, the connector may be easy to access, attach and detach, in case the Carry Pack needs to be removed frequently.

The Carry Pack may further include one or more secondary attachment points on each side panel. In some embodiments, the secondary attachment points may be placed at the bottom half of the side panels. In some embodiments, the secondary attachment points may be placed at the juncture between the side panels and the back panel at the bottom half of the Carry Pack. In some embodiments, the secondary attachment points may secure the lower portion of the Carry Pack snugly to the backrest of the wheelchair when the backrest is tilted. In some embodiments, the secondary attachment points may be secured to the bottom of the back canes of a wheelchair to keep the Carry Pack aligned with the attached surface during for example rear or sideward tilts. The secondary attachment points may include any suitable attachment mechanism such as loops, buckles, hooks, ties, etc. In some embodiments, the secondary attachment mechanisms may be easy to access, attach and detach, in case the Carry Pack needs to be removed frequently.

In some embodiments, the Carry Pack may include compartments accessible from the top (“top-access compartments”). These compartments may include lids or “top flaps” with closures. In some embodiments, the closures may run three-quarters (¾) of the way around each top flap, with a “hinge” on the remainder of the top flap, allowing the compartments to remain open for, for example, easy and fast access to items that may require immediate use such as medication, cleaning wipes, or a cellular phone. The closures may take any suitable form, such as zippers, Velcro™, hooks, tabs, etc., or a combination thereof.

The top-access compartments may include an opening for, for example, a beverage holder. In some embodiments, the top flap of one or more of the top-access compartments may include an opening to allow for, for example, the insertion of a beverage holder. The beverage holder may be removable. In some embodiments, the beverage holder may be inserted into the opening and may rest on or be suspended above the floor of the top compartment. The beverage holder may be dimensioned to secure a typically-sized beverage (e.g., soda can, coffee cup, or water bottle). In some embodiments, the beverage holder may be about 3″ wide and about 5″ deep, with its center of rotation or articulation higher than a typical filled beverage container. Without being bound to any particular theory, the beverage holder's depth and freedom to rotate from a point above the container's center of mass may make tipping and spilling of the contents of the beverage container less likely, even when the wheelchair seatback is tilted or moved over uneven ground. In some embodiments, the beverage holder may be made from a flexible material, such as a flexible polymer, silicone rubber, etc. In some embodiments, the beverage holder may be a fabric/foam construction such as a foam cylinder which may slip over a plastic-coated cylinder, making it possible to rinse the interior and exterior of the beverage holder. In some embodiments, the foam cylinder may assist in maintaining the fluid temperature. In some embodiments, the foam cylinder may be inserted into the opening in reverse, creating a rain proof seal on the top flap.

In some embodiments, the bottom of the beverage holder may be made from a tacky, rubber material with anti-slip properties, which may secure the beverage holder against the bottom of the top compartment in a position that can be quickly optimized by the attendant caregiver. In the alternative embodiments, the bottom of the beverage holder may be designed to remain suspended above the bottom of the top-access compartment and/or be made from a smooth and slippery surface such that it may swing or slide over the bottom of the top-access compartment toward a vertical alignment when tilted.

In some embodiments, the beverage holder may be washable.

In some embodiments, the front panel may be a flap extending only partially (for example, about three-quarters) up the front face of the Carry Pack. In some embodiments, the flap may be fastened (the “front flap fastening”) to the side panels on both sides using for example zippers, Velcro, hooks, tabs, etc., or a combination thereof. In some embodiments, double-slider, two-way zippers around the front flap and attached to the base may, for example, secure and protect items in the interior of the Carry Pack. These zippers may be actuated from either end and may allow the removal of the front panel entirely, such as for cleaning.

Wheelchair users may require a communication apparatus or enjoy entertainment in the form of music or video games. Their caregivers may also use electronic devices, such as computer tablets, for entertainment or reference. Accordingly, in some embodiments, the Carry Pack may include a pouch. The pouch may be padded to, for example, protect computer tablets or other electronics or fragile items. In some embodiments, the pouch may be removable. The removable pouch may be fastened to the main part of the Carry Pack using a pouch pair fastener such as hooks and loops, slots, snaps, Velcro™, or a combination thereof, etc. In alternate embodiments, the pouch may be fixed. The pouch pair fasteners may be located at the top of the pouch and of the front panel. In some embodiments, the pouch may be configured to swing over and rest on the top of the Carry Pack, for example, to facilitate access to the interior of the Carry Pack when the front flap is open.

In some embodiments, all or part of the interior of the Carry Pack may be brightly colored for, for example, contrast and to make it easier to locate items.

In some embodiments, the interior of the Carry Pack may contain interior trays. The side and back, as well as the front and bottom of the trays may be reinforced with a stiff sheet material, such as plastic, cardboard, foam, etc. The interior trays may be horizontal. The interior trays may be removable and repositionable within the Carry Pack using, for example, interior pair fasteners where one of the pair is located on the inside of each of the side panels, and optionally back panel, and the second of the pair is located on the outside of the horizontal trays. The pair fasteners may be any suitable system, such as Velcro™, hooks, snaps, etc. In some embodiments, the interior trays may be fastened to the interior of the Carry Pack using vertical strips of, for example, loop Velcro™ or other flexible attachment system, located on the interior of the Carry Pack. This may facilitate wiping down the inside of the Carry Pack. In some embodiments, the interior trays may include pair fastener on the outside of the sides, and optionally back, of the trays (“tray pair fasteners”). It is to be understood that the tray pair fastening system will be complementary to the interior pair fastening system. In some embodiments, the interior trays may be removable and repositionable by adhering horizontal hook Velcro™ strips on three sides of each tray to the vertical strips of loop Velcro™ on the interior walls of the Carry Pack.

In some embodiments, the base of the Carry Pack may be integral with the front flap. In the embodiments, the integrated front flap and base may be secured to the bottom of the back panel using a suitable pair fastener (the “front flap bottom fastener”).

In some embodiments, the Carry Pack may include an additional perforated base or “bottom net” to for example allow damp or wet items to drain and dry The perforated base or bottom net may be removable. In some embodiments, the bottom net may be used to hold the wettest items, to allow water to drain, and/or to catch any items that may fall from a tray above. The bottom net may be secured to the interior of the side panels with a pair fastener, such as snap fits. In some embodiments, the bottom net may be washable. In some embodiments, the bottom net may be made of coated plastic mesh, etc.

In some embodiments, the Carry Pack may include a recess at the top center of the back panel such that the headrest post and hardware of a wheelchair can be nested within the recess. This recess may provide a snug fit for the Carry Pack, keeping its center of mass tight to the wheelchair back.

In some embodiments, the Carry Pack may include a removable handle or strap if for example there is a need to transport the Carry Pack when not affixed to the wheelchair. In some embodiments, the primary attachment point connectors may attach to a carry strap that allows the Carry Pack to be carried over the shoulder. Alternatively, in some embodiments, a carry handle can be removably attached to the Carry Pack using rear attachment points, such as D-rings, webbing, buckles, etc.

In some embodiments, the Carry Pack may allow for items to be separated vertically. In some embodiments, the Carry Pack may allow for items to be separated in water-resistant or waterproof compartments so that, for example, items which need to be kept clean and dry, such as medications or electronics, are not soiled by leaks and spills from medication, food and drink or soiled clothing and bibs.

In some embodiments, the exterior of the Carry Pack may be constructed out of a sturdy, waterproof synthetic fabric, a hard plastic or metal, or any other material that is easy to clean and holds its shape under load. The interior shelves may also be constructed from a sturdy, wipe-able material. Other materials used in the Carry Pack may include nylon webbing, nylon mesh material, plastic closed cell foam, zippers and metal snaps.

In some embodiments, the exterior and interior of the Carry Pack may be made of materials that are easy to rinse off and wipe down with common household detergents. Similarly, the interior trays may be removed, rinsed off and wiped down. In some embodiments, the removal of the inside trays and the vertical positioning of interior pair fastener, such as loop Velcro™ strips or other flexible attachment system, may facilitate wiping down the inside of the Carry Pack. In some embodiments, it may be possible to drain spilled liquids out of the bottom of the bag and dry the interior of the bag in transit, or when the rest of the Carry Pack is closed, by unfastening the bottom of the front flap. Wet items such as bibs or clothing, stowed in the bottom net can then drain and dry.

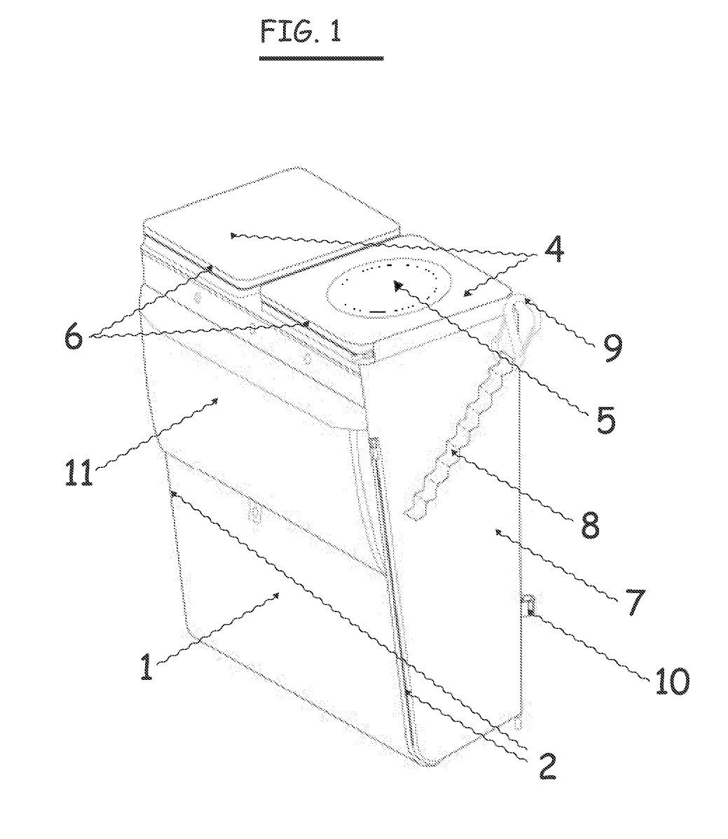

In one embodiment, a Carry Pack in accordance with the present disclosure includes primary attachment points 8 (e.g., a webbing loop ladder) and connector 9 (e.g., a S-shaped dual carabiner) on side panel 7, as shown in FIG. 1. In this embodiment, the Carry Pack can be attached to the back canes of a wheelchair using connector 9. Connector 9 can be repositioned on the primary attachment points 8 to optimize the location of the Carry Pack on the wheelchair. FIG. 1 also shows a secondary attachment point 10 at the bottom half of the Carry Pack, top-access compartments 4 with closures 6 (e.g., a zipper), front flap 1, front flap side fastenings 2 (e.g., a zipper) and pouch 11.

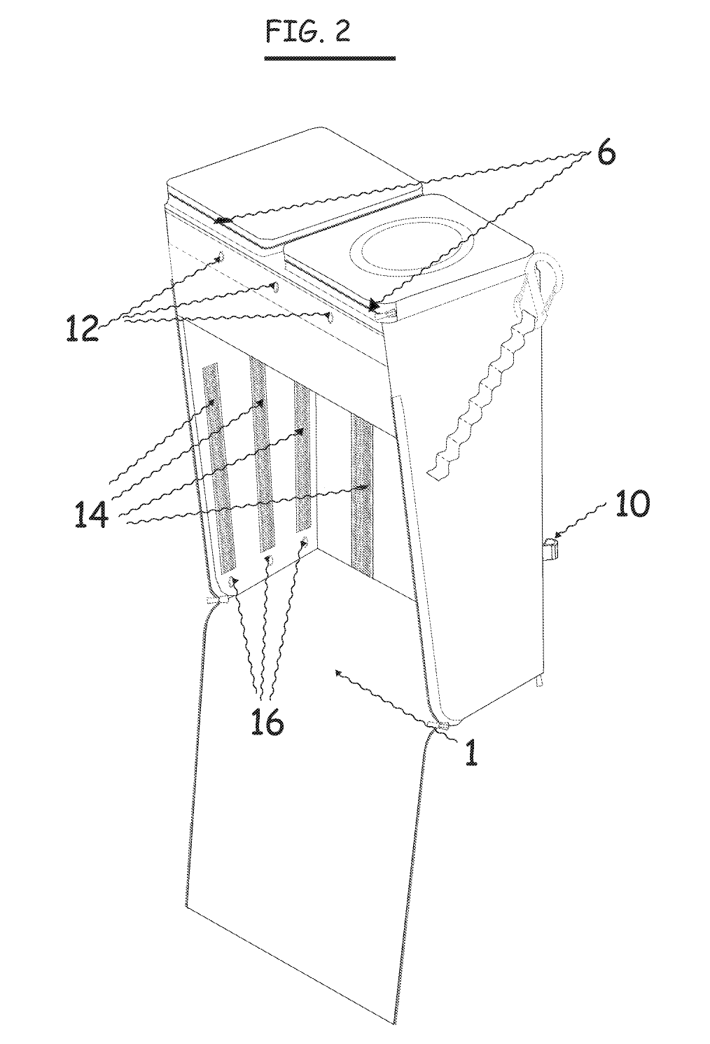

FIG. 2 shows one embodiment of the Carry Pack with front flap 1 in an open configuration, revealing interior with interior pair fastener 14 (e.g., loop Velcro™), pouch pair fasteners 12 (e.g., snap fits), bottom net pair fasteners 16 (e.g., snap fits), top access compartment closures 6 (e.g., a zipper), secondary attachment point 10 and front flap 1 open.

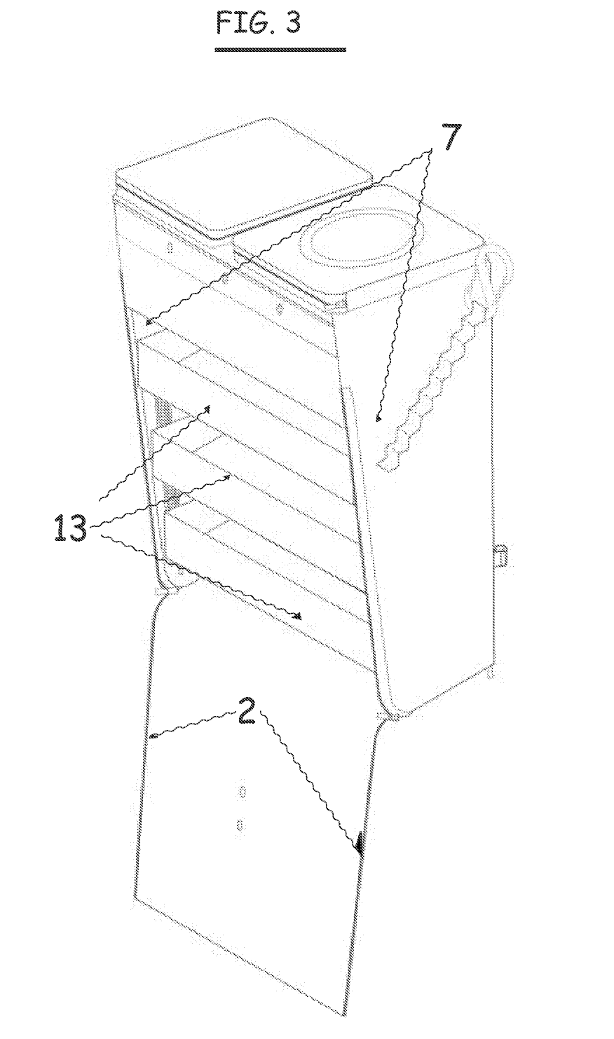

FIG. 3 shows one embodiment of the Carry Pack with the front flap in an open configuration, revealing interior horizontal trays 13 and front flap side fastener 2 (e.g., double-slider, two-way zipper) attached to side panels 7.

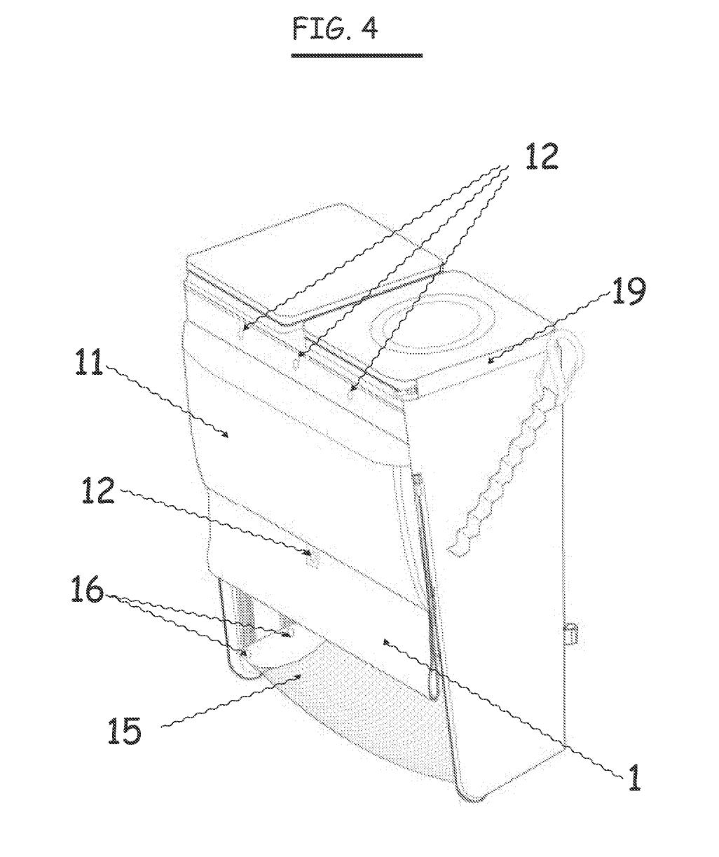

FIG. 4 shows one embodiment of the Carry Pack with the front flap 1 in a partially open configuration. It shows a top flap hinge 19, a bottom net 15, and bottom net fasteners 16 (e.g., snap fits). This configuration may allow wet items such as clothing or bibs to drain and dry while the chair is in use. FIG.4 depicts the pouch 11 with three pair attachments 12 (e.g., snap fit) on top and one pair attachment fit (e.g., snap fit) on a tab at the bottom of the pouch. The attachment at the bottom of the pouch, which connects to the front flap 1, prevents the pouch from swinging as the wheelchair tilts and secures the flap in a partially open configuration.

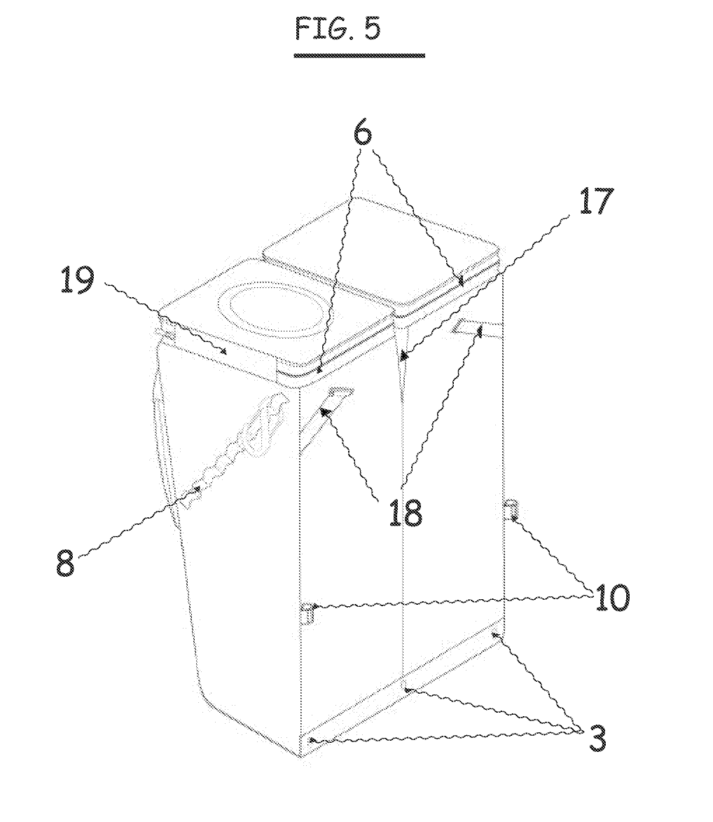

FIG. 5 shows one embodiment of the Carry Pack with front flap bottom fasteners 3 (e.g., a snap fit), top flap fasteners 6, recess 17, as well as both secondary attachment points 10 located at the bottom half of the Carry Pack.

FIG. 5 also shows rear attachment points 18 (e.g., webbing anchors securing D-rings) at the back of the Carry Pack. A carry handle or strap (not shown) can be clipped onto rear attachment points 18 if there is a need to transport the Carry Pack when not affixed to the wheelchair.

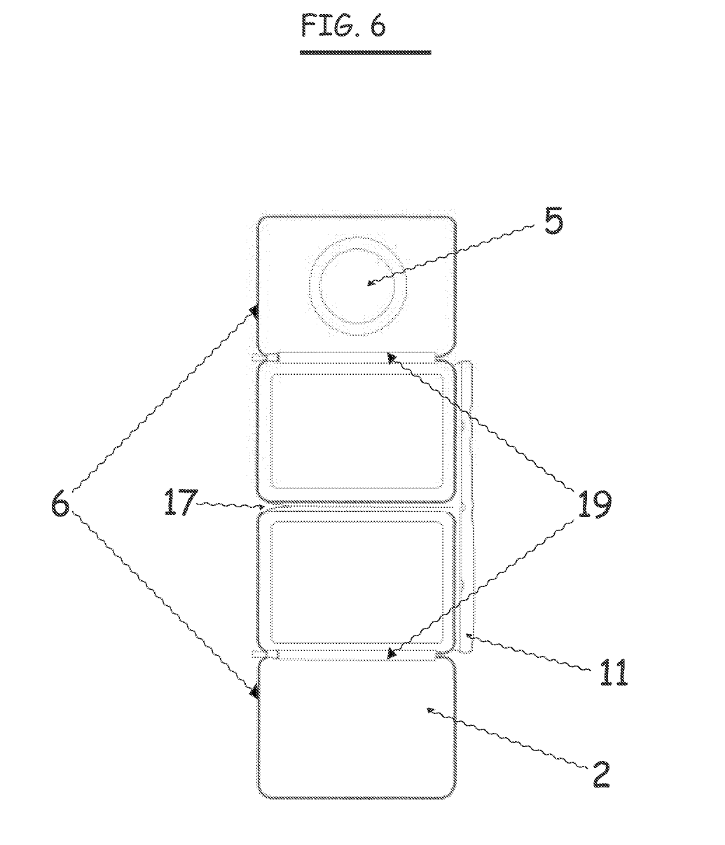

FIG. 6 shows a top view of one embodiment of the Carry Pack with two top-access compartments in an open configuration, in which top flap fasteners 6, and top-access compartment hinges 19 (e.g., of fabric), and opening in top access compartment 5 for beverage container. FIG. 6 also shows recess 17, and pouch 11.

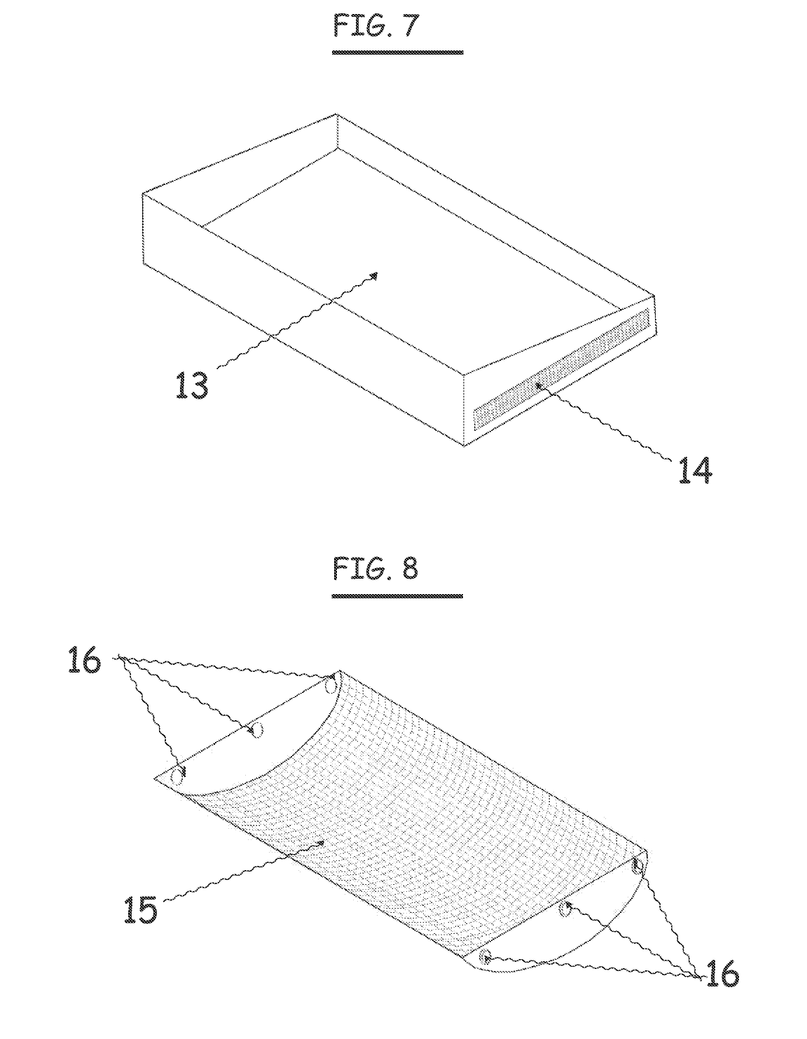

FIG. 7 shows one embodiment of the interior trays 13 of the Carry Pack with the tray pair fastener 14 (e.g., hook Velcro™).

FIG. 8 shows one embodiment of the bottom net 15 (e.g., plastic coated netting), showing bottom net fasteners 16.

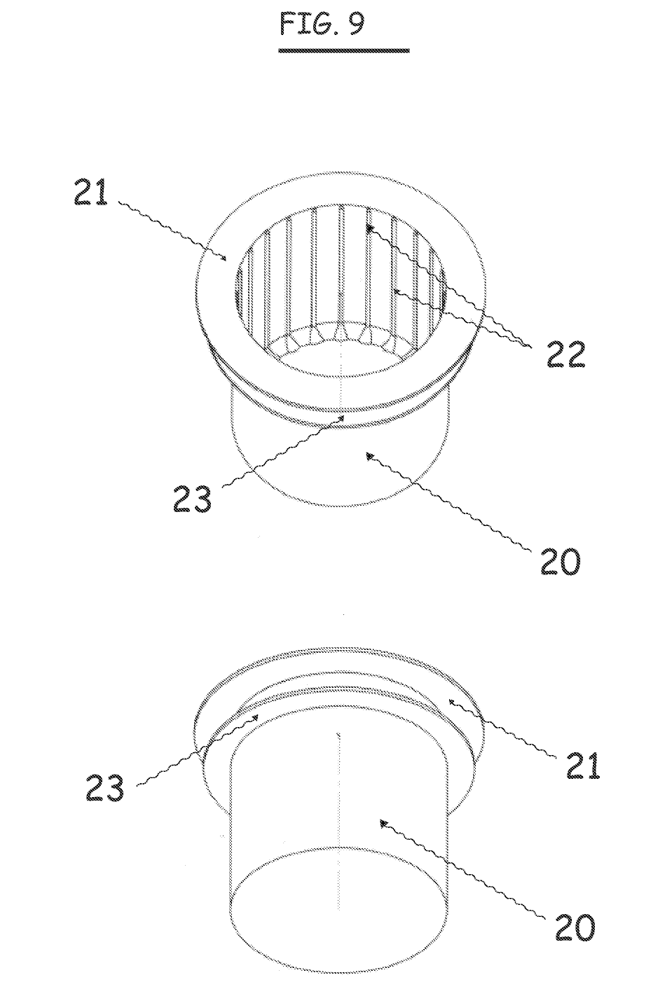

FIG. 9 shows one embodiment of a beverage holder 20, made from a flexible material, with a flexible top ring 21, in which inner ribs 22 may prevent the beverage container from creating a vacuum when being pulled out. The outside bottom rim 23 may be shaped to secure the holder in the opening.

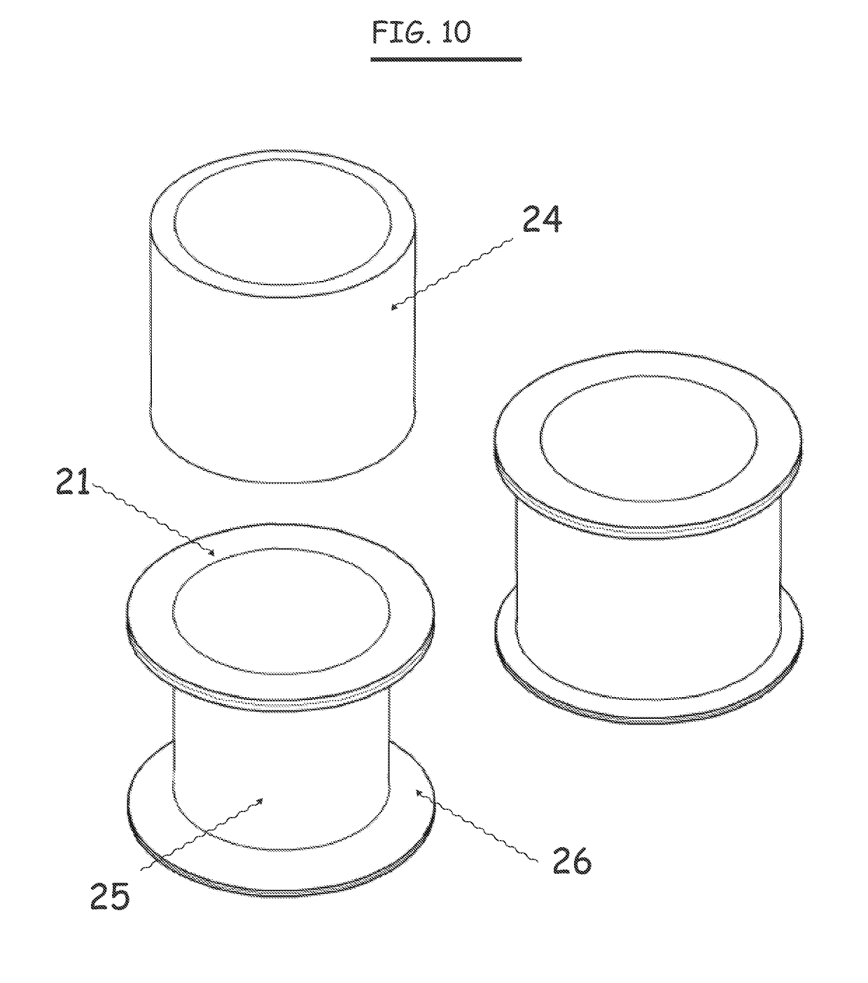

FIG. 10 shows one embodiment of a beverage holder, which is a foam cylinder 24 with a thin waterproof inner cylinder 25, a flexible top rim 21 and a round bottom 26, which may be made from a tacky, rubber material with anti-slip properties.

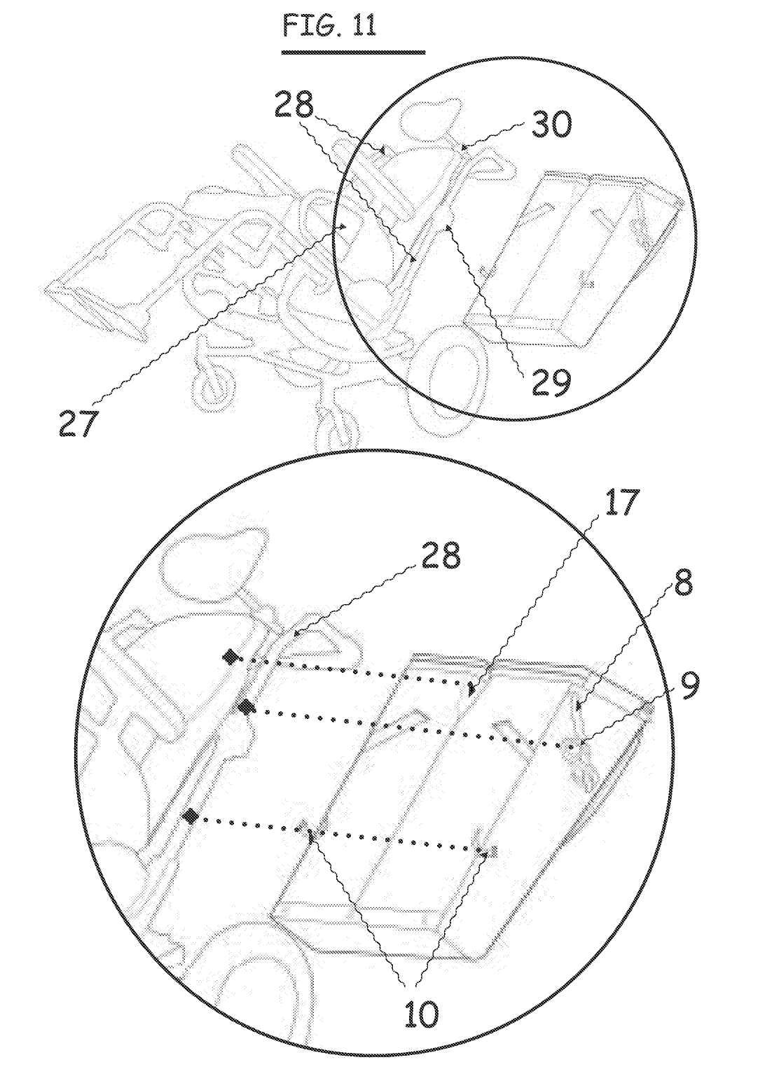

In some embodiments, the Carry Pack may be affixed to the vertical back canes 28 of a wheelchair, such as a manual tilt-in-space wheelchair, directly behind the backrest and headrest mount 30 and between the wheels, as shown in FIG. 11. FIG. 11 shows the relevant features of a tilt-in-space wheelchair 27, such as the back canes 28, an example of a headrest mount 30, and an example of hardware 29 to attach the back rest to the canes. It shows one embodiment of an attachment strategy for the Carry Pack, with the primary attachment points 8, allowing the connectors 9 to be set at the optimal height to match with the backrest mounting hardware. The secondary attachment points 10 attach to the wheelchair back canes 28 just above the seat back connector hardware 29. The recess for the headrest mounting hardware 17 provides a void for the bottom of the headrest mounting hardware, allowing for a snug fit against the back in between the two canes 28.

The present invention has been described with regard to one or more embodiments. However, it will be apparent to persons skilled in the art that a number of variations and modifications can be made without departing from the scope of the invention as defined in the claims.

What is claimed is:

1. A carry pack comprising a central compartment defined by two side panels, a front panel, a back panel, a base and a top, wherein the side panels comprise a plurality of primary attachment points attachable to the back canes of a wheelchair with a connector complementary to the primary attachment points.

2. The carry pack of claim 1 wherein the connector comprises a hook, a carabiner, a buckle, or a tie fastener.

3. The carry pack of claim 1 wherein the primary attachment points are positioned at the top half of the side panels.

4. The carry pack of claim 1 wherein the primary attachment points are positioned at various locations in the side panels.

5. The carry pack of claim 1 wherein the primary attachment points are positioned at a diagonal in the side panels.

6. The carry pack of claim 1 wherein the primary attachment points comprise loops, buckles, hooks, ties or elastics.

7. The carry pack of claim 1 further comprising a plurality of secondary attachment points positioned at the bottom half of the side panels, wherein the secondary attachment points are attachable to the back canes of the wheelchair.

8. The carry pack of claim 7 wherein the secondary attachment points comprise loops, buckles, hooks, ties or elastics.

9. The carry pack of claim 1 further comprising a top-access compartment.

10. The carry pack of claim 9 wherein the top-access compartment comprises a beverage holder.

11. The carry pack of claim 1 further comprising a pouch attachable to the exterior of the carry pack.

12. The carry pack of claim 11 wherein the pouch is removable.

13. The carry pack of claim 1 wherein the interior of the central compartment comprises a plurality of interior trays.

14. The carry pack of claim 13 wherein the interior trays are removable.

15. The carry pack of claim 13 wherein the interior trays are repositionable.

16. The carry pack of claim 1 wherein the base is porous.

17. The carry pack of claim 1 wherein the base is removable.

18. The carry pack of claim 1 wherein the carry pack is made of a waterproof material.

19. The carry pack of claim 1 wherein the carry pack is made of a washable material.

20. The carry pack of claim 1 wherein the wheelchair is a tilt-in-space wheelchair.
